(19) United States
(12) Patent Application Publication
(10) Pub. No.: US 2006/0233986 A1
(43) Pub. Date: Oct. 19, 2006

(54) Composition for controlled tempering by means of phase change, production and use thereof

(76) Inventors: Bernhard Gutsche, Hilden (DE); Gerhard Wollmann, Hilden (DE); Albert Strube, Neuss (DE); Eike Ulf Mahnke, Ratingen (DE)

Correspondence Address: COGNIS CORPORATION;PATENT DEPARTMENT, 300 BROOKSIDE AVENUE, AMBLER, PA, 19002, US

(21) Appl. No.: 10/544,023

(22) PCT Filed: Dec. 19, 2003
(86) PCT No.: PCT/EP03/14595

§ 371 Date: Jan. 10, 2006

(30) Foreign Application Priority Data
Jan. 29, 2003 (DE) 103 03 334.3

(51) Int. Cl. B32B 27/32

(52) U.S. Cl. 428/35.2

(57) ABSTRACT

This disclosure relates to a heat or cold storage composition comprising at least one continuous and at least one discontinuous phase, the continuous phase being liquid or at least plastic at a temperature of −10 to 50° C. and the discontinuous phase—present in the continuous phase—being particulate and containing as phase change material (PCM) at least 10% by weight of an organic compound with a melting point of 0 to 50° C. and at least one structuring polymeric compound. It also relates to the use of a composition according to the invention for controlled heating/cooling by phase change and to a device for the controlled heating/cooling of an object by phase change at least comprising a container for holding a composition according to the invention.

This invention relates to a composition comprising at least one continuous and at least one discontinuous phase, the continuous phase being liquid or at least plastic at a temperature of −10 to 50° C. and the discontinuous phase—present in the continuous phase—being particulate and containing as phase change material (PCM) at least 10% by weight of an organic compound with a melting point of 0 to 50° C. and at least one structuring polymeric compound.

In another embodiment of the invention, a composition according to the invention of a continuous phase and disperse phase is used as part of a device for the controlled heating/cooling of an object by phase change. Suitable devices comprise at least one container which is designed to accommodate a composition according to the invention as described hereinafter.

The storage of heat or cold and the controlled and prolonged heating/cooling of living or inanimate objects is a problem commonly encountered in many branches of industry, in the home and in the medical field. In particular, the cooling of objects or body parts without using electrically operated equipment often presents problems.

Many injuries of body parts, for example injuries which may often be collectively referred to as “sports injuries”, often cause the injured person considerable pain and thus seriously affect their sense of wellbeing. Such sports injuries often involve bruising or fractures which often lead to tissue damage, under-skin bleeding and hence swelling of the affected area. In many cases, inflammation also occurs, resulting in swelling of the affected body part and in the considerable generation of heat in that body part.

In order to improve the wellbeing of people affected by such sports injuries or by illnesses involving the generation of heat over a large area, the cooling of affected body parts has long been applied as a method of improving wellbeing.

Although means generally available in the home, such as damp cloths or bags filled with ice cubes, are often used for this purpose, they do have a number of disadvantages, for example in regard to their cooling performance and in regard to their heatability/coolability or adaptability to various object or body shapes.

In order to remedy this disadvantage, there are various known means and devices which are intended to facilitate the cooling of objects and, in particular, body parts.

For example, U.S. Pat. No. 3,885,403 describes a device which is suitable for use as a hot or cold compress. The device comprises a flexible jacket filled with a gel which retains its gel-like consistency over a broad temperature range. Unfortunately, the device disclosed in the document in question has the disadvantage that the gel gradually heats up and no longer cools at a constant temperature. Accordingly, its cooling effect deteriorates with time and is unsatisfactory for many applications.

U.S. Pat. No. 4,377,160 describes a self-adhesive, compressing bandage which is designed to compress and cool an injured body part of a human being or animal. The bandage consists of a flexible synthetic resin foam impregnated with an aqueous gel. Apart from the fact that such devices can generally be used only once, the described bandage has the disadvantage that its cooling effect is frequently unsatisfactory.

U.S. Pat. No. 4,711,813 describes a composition for storing thermal energy. The composition consists of a crosslinked polyethylene treated with a long-chain alkyl hydrocarbon as phase change material (PCM). The described compositions are used as parts of floor or wall coverings.

WO 90/01911 describes an orthopaedic device comprising a gel pad. The gel pad contains a gel and at least one phase change material which may be encapsulated. However, the problem with such compositions is often that the capsules lack mechanical strength and are destroyed whenever the device is exposed to above-average stress. Unfortunately, this generally results in at least partial loss of the cold- storing properties.

U.S. Pat. No. 4,617,332 describes compositions containing crystalline long-chain hydrocarbons as phase change materials. The described materials are used, for example, in building materials.

Although the problems described above were largely described with reference to the application of such cooling units to living objects, similar problems are also basically encountered in the cooling of inanimate objects, for example in the cooling of machine parts, reactors and the like. In their case, too—unless a corresponding cooling system using electricity is permanently installed—there is a need for flexibility in regard to the application of such a cooling unit and, in particular, for flexibility in regard to adaptation to certain contours of a corresponding structural element. In addition, the cooling effect is intended to lead to prolonged and exact temperature control of the corresponding structural part.

There was therefore a need for compositions, processes for their production and devices using such compositions which would not have any of the disadvantages of the prior art cited above.

Accordingly, the problem addressed by the present invention was to provide compositions which would facilitate the prolonged heating/cooling of objects. Another problem addressed by the present invention was to provide compositions which would comprise a high percentage of a phase change material without the mechanical properties of the material being adversely effected. A further problem addressed by the present invention was to provide a composition containing a particulate phase change material which, even in molten form, would retain its particulate form, would essentially not mix with a carrier material surrounding the particles and, preferably, would retain these properties substantially completely, even under mechanical stress.

Another problem addressed by the invention was to provide a process for the production of such a composition and, more particularly, a process for the production of such a particulate phase change material. An additional problem addressed by the present invention was to provide a device which would contain a composition according to the invention and which could be used for cooling living or inanimate objects.

The problems addressed by the invention are solved by compositions, processes for their production and by devices which are described in the following.

Accordingly, the present invention relates to a composition comprising at least one continuous and at least one discontinuous phase, the continuous phase being liquid or at least plastic at a temperature of −10 to 50° C. and the discontinuous phase—present in the continuous phase—being particulate and containing as phase change material (PCM) at least 10% by weight of an organic compound with a melting point of 0 to 50° C. and at least one structuring polymeric compound.

The present invention also relates to a process for the production of a particulate PCM sponge in which a droplet-forming aqueous dispersion containing at least one polymer with acid groups, at least one water-insoluble organic compound with a melting point of 0 to 50° C. and at least one emulsifier is added dropwise to an aqueous solution of a cation with a valency of at least two in relation to the acid groups of the polymer in such a way that droplets with an average droplet size of 0.5 to 4 mm are formed.

The present invention also relates to the use of a composition according to the invention for controlled heating/cooling by phase change.

The present invention further relates to a device for the controlled heating/cooling of an object by phase change at least comprising a container for holding a composition according to the invention and such a composition according to the invention.

In a first embodiment of the present invention, a composition according to the invention comprises at least one continuous phase. In the context of the invention, a “continuous phase” is understood to be a phase which communicates with the composition as a whole via at least one pathway and, preferably, at least partly surrounds a discontinuous phase. In the context of the present invention, the continuous phase is at least partly assigned the function of guaranteeing or preferably moderating the mobility of the individual particles of the discontinuous phase relative to one another, so that destruction of the particles of the discontinuous phase, even under stress, is largely ruled out. For example, the continuous phase may completely surround the discontinuous phase over its entire surface. However, in an alternative embodiment of the invention, for example, the continuous phase only partly surrounds the particles of the discontinuous phase or coats the surface of the particles of the discontinuous phase with a film. The properties of the continuous phase and, in particular, their influence on the behavior of the particles of the discontinuous phase towards one another can be influenced, for example, through the ratio of continuous to discontinuous phase, as explained in more detail hereinafter.

Basically, the continuous phase may be formed by any compounds which have a sufficiently low solidification point for the applications envisaged for the present invention and which do not have any adverse effect in the context of the present invention on the discontinuous phase.

The continuous phase is preferably a gel-like liquid, more particularly an aqueous gel. In addition, the gel should have a sufficiently high viscosity to surround the discontinuous phase substantially completely at least throughout the application of the composition or—providing the ratio of continuous to discontinuous phase permits—to suspend the discontinuous phase at least in the temperature range envisaged for the application. Preferably, the gel should not freeze on cooling and should still be plastic or liquid when cold.

Suitable gels can be obtained, for example, on the basis of water, an additive which sufficiently lowers the freezing point of water and, if the viscosity of this mixture is inadequate for the purposes of the invention, optionally a thickener.

Basically, suitable compounds which lower the freezing point of water are, for example, polyols, such as ethylene glycol, diethylene glycol, propylene glycol, glycerol, lower oligomers of glycerol, such as diglycerol or triglycerol, monoesters of short-chain fatty acids (about 2 to about 8 carbon atoms) with trimethylol propane, triethylol propane, pentaerythritol or sugar alcohols or polyether compounds, such as polyethylene glycol, preferably polyethylene glycol with a molecular weight in the range from about 200 to about 600 kg/mol, monoesters of unsaturated fatty acids, such as oleic acid, linoleic acid or linolenic acid with trimethylol propane, triethylol propane, pentaerythritol or sugar alcohols or polyether compounds, such as polyethylene glycol, preferably polyethylene glycol with a molecular weight in the range from about 200 to about 600 kg/mol and trimethylol propane, triethylol propane, pentaerythritol or sugar alcohols or polyether compounds, such as polyethylene glycol, preferably polyethylene glycol with a molecular weight in the range from about 200 to about 600 kg/mol.

In a preferred embodiment of the present invention, glycerol is used as the compound lowering the freezing point of water.

Basically, suitable thickeners are any substantially water-soluble compounds which increase the viscosity of an aqueous solution of such a compound significantly and adequately for the purposes of the invention. Water-soluble polymeric thickeners are particularly suitable.

Basically, suitable polymeric thickeners are polymerization compounds, polyaddition compounds or polycondensation compounds which are sufficiently water-soluble for the purposes of the invention through the presence of suitable functional groups, more particularly carboxyl groups. For example, polyurethanes containing carboxyl groups, which can be obtained in known manner by a polyaddition reaction of polyisocyanates, polyols and polyols containing carboxyl groups, are suitable thickeners. Other suitable thickeners are polyurethanes which have polyalkylene ether chains, for example, and thus possess sufficient solubility in water.

Also suitable, but less preferred, for the purposes of the invention are polycondensation compounds, for example polyester compounds of which the solubility is guaranteed by polyethylene ether groups or acid groups or both.

Polymers, more particularly polymers of acrylic acid or methacrylic acid or mixtures thereof, may also be used for the purposes of the invention and are preferred as thickeners.

Since the thickeners mentioned contain acid groups, so that the pH of the gel would fall into a non-preferred acidic range, the acid groups are preferably neutralized before the thickener is used. A hydroxide of an alkali metal, more particularly NaOH, is normally used for this purpose. However, polyacrylic acid derivatives neutralized with ammonium hydroxide or organic amines, such as monoethanolamine, triethanolamine, diisopropanolamine, di-(2-ethylhexyl)-amine, triamylamine or the like, may also be used. The neutralization is preferably continued until the corresponding gels have a pH in a suitable range of about 5 to about 8.5.

In a preferred embodiment of the present invention, a gel suitable for use as the continuous phase in the present case contains, for example, about 1 to about 10% by weight of a polyacrylic acid, about 1 to about 10% by weight glycerol and about 40 to about 98% by weight water.

In the present case, the pH of the gel is largely within a range of about 5 to about 8.5, but preferably within a range of about 6 to about 8 and more particularly within a range of about 6.5 to about 7.5.

In addition, a gel suitable for use as the continuous phase in accordance with the invention may contain other additives if desired. Other suitable additives are, for example, dyes or pigments, preservatives, heat stabilizers, UV stabilizers, salts and the like.

According to the invention, so-called “PCM sponges” are used as the discontinuous phase. In the context of the present invention, a “PCM sponge” is a particle which contains at least one structuring polymeric compound and at least 10% by weight of an organic compound with a melting point of about 0 to about 50° C., the structuring polymeric compound forming part of the particle over virtually its entire cross-section. Accordingly, a PCM sponge used in accordance with the invention does not have a “core/shell” structure.

A “PCM sponge” in the context of the present invention is distinguished in particular by the fact that the particle form largely does not change when the organic compound changes from the solid phase into the liquid phase and vice versa under a constant external load and, even when the organic compound is present in liquid form, the particle can be exposed to an external force without deliquescing or disintegrating into individual fragments. A PCM sponge used in accordance with the invention differs basically from the organic compound present in it which would not retain its original shape in the molten state after a corresponding treatment.

A preferred embodiment of the present invention is characterized by the use of PCM sponges which, with the organic compound in the molten state, are capable of withstanding an external force of at least 5 N/cm² largely without returning to their original shape after removal of the external force. Preferably, the PCM sponges can be exposed to a force of at least about 7 N/cm² and, more particularly, of at least about 10 N/cm².

The particle size of the discontinuous phase is preferably in the range from about 0.5 to about 4 mm and more particularly in the range from about 1 to about 3 mm. The particle size may be determined, for example, by microscopic methods as generally known to the expert.

The PCM sponges according to the invention preferably contain polymers with two or more anionic groups and, more particularly, with at least three or more anionic groups as structuring polymeric compounds. Basically, virtually any anionic groups capable of entering into a stable crosslinking reaction (i.e. “stable” in the context of the invention) with divalent or polyvalent cations are suitable. However, structuring polymers containing carboxyl groups as anionic groups are preferably used.

Suitable compounds containing carboxyl groups are, for example, the anionic polymers mentioned above in the explanation of the thickeners in the continuous phase. In a preferred embodiment of the invention, however, polymers based on starch or cellulose are used. According to the invention, preferred polymers containing anionic groups are, for example, alginate or cellulose compounds, more especially sodium alginate, barium alginate, carboxymethylated chitin or chitosan, carboxymethyl starch or carboxymethyl cellulose.

According to the invention, suitable organic compounds with a melting point in the range from about 0 to about 50° C. are basically any organic compounds which, together with a corresponding structuring polymeric compound as described above, form a PCM sponge suitable for use in accordance with the invention. For example, wax-like hydrocarbon compounds with a corresponding melting point are suitable. Such compounds include, for example, crystalline long-chain alkyl hydrocarbons containing about 10 to about 18 carbon atoms and mixtures thereof.

In a preferred embodiment, however, organic substances obtainable from natural renewable raw materials based on vegetable or animal fats and oils are used as organic compounds in the PCM sponges used in accordance with the invention. Suitable organic substances are, for example, the aldehydes obtainable therefrom; alkanolamides, alkyl polyglycosides; fatty acid alkyl esters, more particularly methyl esters, ethyl esters, butyl esters; fatty alcohols; ocenols, Guerbet alcohols, fatty acids, glycerol, ethoxylated glycerol, fatty acid monoglycerides, diglycerides or triglycerides; polyethylene glycol with a molecular weight of about 400 to about 1,000; alkyl sulfosuccinate salts; fatty alcohol sulfate salts; salts of fatty acids, and ethoxylated triglycerides.

The compounds listed in the following Tables, of which the softening point or softening range is shown in brackets, are particularly suitable. The Tables show the class of the corresponding compound, its chemical name, the trade name under which the corresponding compound can be obtained, for example, from Cognis Deutschland GmbH & Co. KG, the CAS No. and the minimal and maximal softening points (SP min. and SP max. in ° C.).

| | | | | SP | SP |
|---|---|---|---|---|---|
| | Cognis trade | | | min | max |
| Class | name | Chem. Name | CAS | ° C. | ° C. |
| Aldehyde | Aldehyde C-12 | C12 Aldehyde; Dodecanal | 112-54-9 | 11.0 | 11.0 |
| Aldehyde | Aldehyde C-14 | C14 Aldehyde; Tetradecanal | 124-25-4 | 23.0 | 23.0 |
| Aldehyde | Aldehyde C-16 | C16 Aldehyde; Hexadecanal | 629-80-1 | 34.0 | 34.0 |
| Aldehyde | Aldehyde C-18 | C18:0 Aldehyde; Stearic aldehyde | 638-66-4 | 33.0 | 38.0 |
| Alkanol- | ComperlanLMD | C12-C14 Lauric/myristic acid | 97926-10-8 | 31.0 | 37.0 |
| amide | | diethanolamide C12-C14 | | | |
| Alkanol- | Compertan VOD | Fatty acid diethanolamide | 68155-26-0 | 5.0 | 5.0 |
| amide | | based on vegetable oils | | | |
| Alkanol- | Comperlan | Coconut fatty acid | 68425-44-5 | 25.0 | 30.0 |
| amide | 100 + 8EO | monoethanolamide + 8EO | | | |
| APG | Plantaren 1200 | C12-16-Fatty alcohol-1,4- | 110615-47-9 | 35.0 | 40.0 |
| | | glucoside | | | |
| Ester | Emerest 2325 | C18:0 Stearic acid butyl ester | 123-95-5 | 17.0 | 21.0 |
| Ester | CegesoftC17 | Lactic acid tetradecyl ester | 1323-03-1 | 29.0 | 34.0 |
| Ester | Hydropalat 88 | Sulfosuccinic acid diisododecyl | 29857-13-4 | 5.0 | 5.0 |
| | | ester sodium salt | | | |
| Ethylester | Ethylester C14 | C14 Ethylester; tetradecanoic | 124-06-1 | 12.3 | 12.3 |
| | | acid ethyl ester | | | |
| Ethylester | Ethylester C16 | C16 Ethylester; hexadecanoic | 628-97-7 | 24.4 | 24.4 |
| | | acid ethyl ester | | | |
| Ethylester | Ethylester C18 | C18:0 Ethylester; octadecanoic | 111-61-5 | 33.9 | 33.9 |
| | | acid ethyl ester | | | |
| Ethylester | Ethylester C20 | C18:1 Ethylester; octadecanoic | 111-62-6 | 5.8 | 5.8 |
| | | acid ethyl ester | | | |
| Fatty | Lorol C10 | C10 Fatty alcohol | 112-30-1 | 3.0 | 6.0 |
| alcohol | | | | | |
| Fatty | Lorol 1216 | C10-16 Fatty alcohol | 67762-41-8 | 18.0 | 22.0 |
| alcohol | | | | | |
| Fatty | Lorol C12 | C12 Fatty alcohol; Lauric alcohol | 112-53-8 | 23.7 | 23.9 |
| alcohol | | | | | |
| Fatty | LorolC12-14N | C12-14 Fatty alcohol | 80206-82-2 | 17.0 | 23.0 |
| alcohol | | | | | |
| Fatty | LorolC12-16 | C12-16 Fatty alcohol | 68855-56-1 | 22.0 | 25.0 |
| alcohol | | | | | |
| Fatty | Lorol technisch | C12-18 Fatty alcohol | 67762-25-8 | 18.0 | 23.0 |
| alcohol | | | | | |
| Fatty | LorolC14 | C14 Fatty alcohol; Myristyl alcohol | 112-72-1 | 35.0 | 38.0 |
| alcohol | | | | | |
| Fatty | HD Ocenol | C14-C18 + C16-18:1 | 68155-00-0 | 19.0 | 26.0 |
| alcohol | 70/75 V | Oleylcetylalcohol. vegetable | | | |
| Fatty | HD Ocenol | C16-18 + C18:1-Fatty alcohol. | 68002-94-8 | 6.0 | 10.0 |
| alcohol | 90/95 | unsaturated | | | |
| Fatty | HD OcenolNRa | C16-18 Fatty alcohol. | 68002-94-8 | 5.0 | 15.0 |
| alcohol | | unsaturated | | | |
| Fatty | HD Ocenol | C18:1 Fatty alcohol oleyl cetyl | 68155-00-0 | 30.0 | 37.0 |
| alcohol | 30/40 | alcohol | | | |
| Fatty | HD Ocenol | C18; C18:1 Stearyl/oleyl alcohol | 68002-94-8 | 2.0 | 6.0 |
| alcohol | 93/96 | mixture | | | |
| Fatty | Erucaalkohol | C22 Fatty alcohol.docosenol-1 | 629-98-1 | 24.0 | 30.0 |
| alcohol | | *13-cis- | | | |
| Fatty | LorolC10-12 | C8-12 Fatty alcohol | 84539-75-3 | 0.0 | 0.0 |
| alcohol | | | | | |
| Gly + EO | CutinaE 24 | Glycerol monostearate + 24- | 68153-76-4 | 18.0 | 21.0 |
| | | EODAC 1986 (3.Lf.88) | | | |
| Glyceride | Novata BCF | Glyceride-Partial glyceride mixture | 67701-26-2 | 33.5 | 38.0 |
| Glyceride | Edenor SPNF 8 | Sperm oil filtrate | 8002-24-2 | 7.0 | 9.0 |
| Glycerol | GlycerinPh. | Propanetriol *1.2.3- | 56-81-5 | 18.0 | 18.0 |
| | Eur.99.5% | | | | |
| Guerbet | Eutanol G 32/36 | Guerbet alcohol-C16-18 pure | 90604-46-9 | 32.0 | 35.0 |
| alcohol | | | | | |
| Guerbet | Primarol 1511 | Oleic acid (branched-C24-28- | 85203-93-6 | 20.0 | 20.0 |
| alcohol | oleat | alkyl)ester | | | |
| Guerbet | Primarol 1107 | Stearic acid (branched.-C16-20- | 85203-92-5 | 0.0 | 0.0 |
| alcohol | stearat | alkyl)ester | | | |
| Hydrocarbon | Alkan-C16 | C16 Alkane; hexadecane | 544-76-3 | 18.8 | 18.1 |
| Hydrocarbon | Alkan-C18 | C18 Alkane; octadecane | 593-45-3 | 28.0 | 28.0 |
| Methylester | Edenor ME C16 | C16 Fatty acid methyl ester | 112-39-0 | 30.6 | 30.6 |
| | 98 | | | | |
| Methylester | Edenor Me St 1 | C16-18-Fatty acid methyl ester | 85586-21-6 | 25.0 | 27.0 |
| | | mixture | | | |
| Methylester | Edenor ME | C18 Fatty acid methyl ester | 112-61-8 | 37.8 | 37.8 |
| | C18 98 | | | | |
| Methylester | Edenor MEHTi | Tallow fatty acid methyl | 68815-18-9 | 28.0 | 28.0 |
| | | ester.hydrogenated | | | |
| Monoglyceride | Monoglycerid | C18:0 Monoglyceride; octadecenoic | 123-94-4 | 35.0 | 35.5 |
| | C18:1 | acid monoglyceride | | | |
| Monoglyceride | Edenor GMO | C18:1 Monoglyceride; oleic acid | 25496-72-4 | 5.0 | 5.0 |
| | | monoglyceride | | | |
| Monoglyceride | Monoglycerid | C6 Monoglyceride; hexanoic acid | 26402-23-3 | 19.4 | 19.4 |
| | C6 | monoglyceride | | | |
| Monoglyceride | Monoglycerid | C8 Monoglyceride; octanoic acid | 26402-26-6 | 19.4 | 19.4 |
| | C8 | monoglyceride | | | |
| Triglyceride | Triglycerid C8 | C8 Triglyceride; Octanoic acid | 538-23-8 | 8.3 | 8.3 |
| | | triglyceride | | | |
| Triglyceride | Kokosöl | Coconut oil | 8001-31-38 | 21.0 | 25.0 |
| | raffiniert | | | | |
| Triglyceride | Palmkernöl | Palm kernel oil, refined | 8023-79-8 | 24.0 | 30.0 |
| | raffiniert | | | | |
| Triglyceride | Triglycerid | C18:1 Triglyceride; | 122-32-7 | 5.5 | 5.5 |
| | C18:1 | octadecenoic acid triglyceride. | | | |
| | | glycerol trioleate | | | |
| Triglyceride | Triglycrid C22:1 | C22:1 Triglyceride; docososenoic | 137398-69-7 | 30.0 | 30.0 |
| | | acid triglyceride; triglycerol | | | |
| | | erucate | | | |
| Triglyceride + | Crovol PK 70 | Palm kernel oil, ethoxylated | 124046-52-2 | 18.0 | 22.0 |
| EO | | | | | |
| PEG | Polydiol-600 | Polyethylene glycol | 25322-68-3 | 22.0 | 22.0 |
| PEG | Emerest 2661 | Polyethylene glycol-600-monolaurate | 61791-29-5 | 14.0 | 14.0 |
| Salt | Collector SCO | Alkylsulfosuccinate-sodium | 147993-66-6 | 4.0 | 4.0 |
| | 40 | ammonium salt | | | |
| Salt | TexaponLS 35 | Fatty alcohol sulfate sodium salt | 85586-07-8 | 15.0 | 15.0 |
| Salt | EWPOL | Sodium laurate | 629-25-4 | 23.0 | 23.0 |
| | 7902NaC12 | | | | |

The organic compounds usable in accordance with the invention may be used individually. However, it is of advantage according to the invention, for example, to use mixtures of two or more of the above-mentioned compounds.

It is of particular advantage to use mixtures with a composition which forms a type of “eutectic”.

The composition of such a “eutectic” means that crystals with the same composition as the melt are formed on solidification. During solidification, there is no shift in the chain length composition in the crystals compared with the melt. During the melting of a mixture with “eutectic composition”, the melting temperature remains constant for the entire duration of the phase change. According to the invention, cooling during the melting of a mixture with “eutectic composition” surrounded by a PCM sponge can be carried out at a constant cooling temperature for the entire duration of the cooling process.

A preferred embodiment of the present invention is characterized, for example, by the use of a fatty acid mixture with “eutectic composition” of 72 mol-% capric acid and 28 mol-% lauric acid. The melting point of such a “eutectic” mixture is 21° C. whereas the melting points of the pure acids are 31.3 and 44.2° C., respectively.

In another preferred embodiment of the present invention, fatty alcohols, more particularly a C₁₂ fatty alcohol (melting point 24° C.), are used as the organic compounds.

In a particularly preferred embodiment of the present invention, mixtures of fatty alcohols, more particularly a mixture containing a C₁₂ fatty alcohol (melting point 24° C.) and a C₁₄ fatty alcohol (melting point: 38° C.), are used as the organic compounds. A ratio by weight of C₁₂ compounds to C₁₄ compounds of 90:10 to 40:60% is preferably used.

According to the invention, the organic compounds mentioned above act as so-called phase change materials (PCM). On heating, these so-called PCMs dissipate both the latent heat and also the heat of fusion of the PCM. It has been found in accordance with the invention that the above-mentioned PCMs selected on the basis of natural renewable raw materials undergo a small change in volume and show high heat of fusion during phase change. By virtue of the melting point depressions often observed with the mixtures mentioned above, they are particularly suitable for the production of “made-to-measure” products with regard to the dissipation of heat. In addition, the substances mentioned are generally not toxic and are very environment-friendly, so that the escape of a composition according to the invention from a device as described hereinafter does not harm either the treated object or a correspondingly treated patient or the environment.

In the present case, the choice of suitable organic compounds was made with regard to the cooling of human body parts to a corresponding temperature range. However, it is clear to the expert that there are different preferred cooling ranges for different objects to be cooled, so that different organic compounds can be selected. Accordingly, in the context of the present specification, the above-described organic compounds emphasized as preferred are not intended to develop a limiting effect to the extent that the subject of the present invention can be carried out with those compounds only. It is within the specialist knowledge of the expert to use another organic compound or a mixture of other organic compounds with a melting point in the desired range for a different application, for example for cooling at a low or higher desired average temperature.

To produce the compositions according to the invention, the above-described PCM sponges are mixed with a suitable gel as the continuous phase.

The mixing ratio may lie within a broad range. For example, the ratio of continuous phase to discontinuous phase may be from about 1:100 to 100:1. Since the dissipation of heat from an object to be cooled or the heat dissipation capacity increases with increasing percentage of discontinuous phase, namely the PCM, it is preferred in accordance with the invention to use a high percentage of PCM in a corresponding composition. Accordingly, compositions with a ratio of continuous to discontinuous phase of at most about 1:1, preferably about 1:9 to 1:20, for example about 1:10 to about 1:15, are preferably used.

The PCM sponges used in a composition according to the invention may basically be produced in any way providing the structure and particle size described above are obtained.

In a preferred embodiment of the present invention, the PCM sponges according to the invention are produced by adding a liquid mixture containing the structuring polymer and the organic compound dropwise to a precipitation bath.

Compositions suitable for conversion into droplets contain at least water and at least one structuring polymer and at least one organic polymer with a melting point in the range from about 0 to about 50° C.

Since the organic compounds used in the PCM sponges suitable for use in accordance with the invention have extremely little, if any, solubility in water, it is of advantage in accordance with the invention, in the production of the PCM sponges suitable for use in accordance with the invention, if the mixture to be converted into droplets is present in the form of an emulsion. Accordingly, in a preferred embodiment of the present invention, mixtures suitable for conversion into droplets contain at least one emulsifier. Suitable emulsifiers are, for example, surfactants, such as alkyl ethoxylates, monoglycerides, alkyl polyglycosides, soaps, alkyl benzenesulfonates, secondary alkanesulfonates, olefin sulfonates, alkyl ether sulfonates, glycerol ether sulfonates, x-methylester sulfonates, sulfofatty acids, alkyl and/or alkenyl sulfates, alkyl ether sulfates, glycerol ether sulfates, hydroxy mixed ether sulfates, fatty alcohol (ether) phosphates, monoglyceride (ether) sulfates, fatty acid amide (ether) sulfates, mono- and dialkyl sulfosuccinates, mono- and dialkyl sulfosuccinamates, sulfotriglycerides, amide soaps, ether carboxylic acids and salts thereof, fatty acid isethionates, fatty acid sarcosinates, fatty acid taurides, N-acylamino acids such as, for example, acyl lactylates, acyl tartrates, acyl glutamates and acyl aspartates, alkyl oligoglucoside sulfates, protein fatty acid condensates (particularly wheat-based vegetable products) and alkyl(ether) phosphates. If the anionic surfactants contain polyglycol ether chains, they may have a conventional homolog distribution although they preferably have a narrow homolog distribution.

Preferred emulsifiers are surfactants selected from the group consisting of alkyl ethoxylates, monoglycerides, alkyl polyglycosides or soaps, more particularly fatty alcohol ethoxylates, fatty alcohol sulfates, secondary alkanesulfonates and linear alkylbenzene sulfonates.

Alkyl Ethoxylates

Alkyl ethoxylates, which are often also referred to as fatty alcohol ethoxylates, are understood to be the ethoxylation products of primary or branched alcohols which correspond to formula (I):
R¹—O—[CH₂—CH₂—O]ₙ—H (I)
where R¹ is a linear or branched, aliphatic alkyl and/or alkenyl group containing 6 to 22 and preferably 12 to 18 carbon atoms, 18:1 and 18:2 carbon atoms. Fatty alcohol ethoxylates containing 1 to 40 and preferably 20 to 30 ethylene oxide units are preferably used.

Typical examples of alkyl ethoxylates which may preferably be used as emulsifiers in accordance with the invention are the ethoxylation products of caproic alcohol, caprylic alcohol, capric alcohol, lauryl alcohol, myristyl alcohol, cetyl alcohol, palmitoleyl alcohol, stearyl alcohol, isostearyl alcohol, oleyl alcohol and the technical mixtures thereof obtained by hydrogenation of technical methylester fractions or fatty acids or triglycerides; and of branched alcohols from oxo syntheses.

Mixtures of cetyl alcohol ethoxylate with stearyl alcohol ethoxylate or with oleyl alcohol ethoxylate containing 20 to 30 ethoxyl groups are particularly suitable for use as emulsifiers.

Alkyl Benzenesulfonates

Alkyl benzenesulfonates preferably correspond to formula (II):
R²—Ph—SO₃X (II)
in which R² is a branched, but preferably linear alkyl group containing 10 to 18 carbon atoms, Ph is a phenyl group and X is an alkali metal and/or alkaline earth metal, ammonium, alkyl ammonium, alkanolammonium or glucammonium. Dodecyl benzenesulfonates, tetradecyl benzene-sulfonates, hexadecyl benzenesulfonates and technical mixtures thereof in the form of the sodium salts are preferably used.
Soaps

Finally, soaps are understood to be fatty acid salts corresponding to formula (II):
R³CO—OX (III)
in which R³CO is a linear or branched, saturated or unsaturated acyl group containing 6 to 22 and preferably 12 to 18 carbon atoms and X is alkali and/or alkaline earth metal, ammonium, alkylammonium or alkanolammonium. Typical examples are the sodium, potassium, magnesium, ammonium and triethanolammonium salts of caproic acid, caprylic acid, 2-ethylhexanoic acid, capric acid, lauric acid, isotridecanoic acid, myristic acid, palmitic acid, palmitoleic acid, stearic acid, isostearic acid, oleic acid, elaidic acid, petroselic acid, linoleic acid, linolenic acid, elaeostearic acid, arachic acid, gadoleic acid, behenic acid and erucic acid and technical mixtures thereof. Coconut oil fatty acid or palm kernel oil fatty acid in the form of their sodium or potassium salts are preferably used.

Partial esters of glycerol or sorbitan with unsaturated, saturated, linear or saturated, branched Cr₆₋₁₈ fatty acids or C₃₋₁₈ hydroxycarboxylic acids and adducts thereof with 1 to 30 mol ethylene oxide are also suitable.

Glycerin Mono-Oleate (for example Edenor GMO, CAS 25496-724), Glycerin Di-Oleate (Edenor GMO H); Glyceryl Laurate (CAS 142-18-7); and Glycerin Monocaprylate (CAS 26402-26-6) (all trade names of Cognis Deutschland GmbH & Co. KG), for example, are particularly suitable.

Sorbitan esters; sorbitan esters ethoxylated and/or propoxylated and mixtures thereof

Also suitable are castor oils and hydrogenated castor oils: for example Eumulgin B1 (CAS 68439-49-6), Eumulgin B2 (CAS 6843949-6), Eumulgin B3 (CAS 6843949-6), Eumulgin L (CAS 187412-42-6), Eumulgin HRE 40 (CAS 61788-85-0), Eumulgin HRE 60 (CAS 61788-85-0), Eumulgin RO 40 (CAS 61791-12-6), Cremophor CO 40 (CAS 61788-85-0), Cremophor CO 60 (CAS 94581-01-8), Cremophor EL (CAS 61791-12-6), Cremophor WO 7 (CAS 61788-85-0), Dehymuls HRE 7 (CAS 61788-85-0), Arlacel 989 (CAS 94581-01-8), all trade names of Cognis Deutschland GmbH & Co. KG

Monoglyceride (Ether)Sulfates

Monoglyceride sulfates and monoglyceride ether sulfates are known anionic surfactants which may be obtained by the relevant methods of preparative organic chemistry. They are normally produced from triglycerides by transesterification to the monoglycerides, optionally after ethoxylation, followed by sulfation and neutralization. The partial glycerides may also be reacted with suitable sulfating agents, preferably gaseous sulfur trioxide or chlorosulfonic acid [cf. EP-B1 0561825, EP-B1 0561999 (Henkel)]. If desired, the neutralized products may be subjected to ultrafiltration to reduce the electrolyte content to a desired level [DE 4204700 A1 (Henkel)]. Overviews of the chemistry of monoglyceride sulfates have been published, for example, by A. K. Biswas et al. in J. Am. Oil. Chem. Soc. 37,171 (1960) and by F. U. Ahmed in J. Am. Oil. Chem. Soc. 67, 8 (1990). The monoglyceride (ether)sulfates suitable for the purposes of the invention correspond to formula (IV): 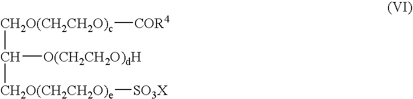
in which R⁴CO is a linear or branched acyl group containing 6 to 22 carbon atoms, c, d and e together stand for 0 or numbers of 1 to 30 and preferably 2 to 10 and X is an alkali metal or alkaline earth metal. Typical examples of monoglyceride (ether)sulfates suitable for the purposes of the invention are the reaction products of lauric acid monoglyceride, coconut fatty acid monoglyceride, palmitic acid monoglyceride, stearic acid monoglyceride, oleic acid monoglyceride and tallow fatty acid monoglyceride and ethylene oxide adducts thereof with sulfur trioxide or chlorosulfonic acid in the form of their sodium salts.
Alkanesulfonates

Alkane sulfonates may be divided into primary and secondary alkanesulfonates. These are understood to be compounds corresponding to formula (V):
R⁵—CH(SO₃H)—R⁶ (V)
where—in the case of primary alkanesulfonates—R⁸ is hydrogen and R⁹ is an alkyl group containing no more than 50 carbon atoms. Secondary alkanesulfonates are preferred.

Besides the emulsifiers mentioned above, compositions suitable for conversion into droplets may contain other ingredients. Another suitable ingredient is, for example, a co-emulsifier or a mixture of two or more co-emulsifiers. These are preferably low molecular weight nonionic compounds, for example fatty acid monoethanolamide. Other suitable co-emulsifiers are, for example, fatty acid isopropanolamide and fatty acid diethanolamide.

C₁₀₋₁₂ fatty acids, for example coconut oil fatty acids or tallow fatty acids, are used as fatty acids.

Basically, other suitable additives are polymeric compounds which can contribute towards adjusting the viscosity of the emulsion to be added dropwise. Suitable polymeric compounds are, for example, nonionic water-soluble polymer compounds, such as polyethylene glycol or polyvinyl alcohol. Polyethylene glycol with a molecular weight of about 150 to about 1,000 is particularly suitable. Also suitable are short-fiber cellulose and polyacrylates with an average molecular weight of 1,000 to 30,000 and the alkali metal salts of maleic acid/acrylic acid copolymers.

Cationic polymers are also suitable for viscosity adjustment and as crosslinking agents. “Cationic polymers” in the context of the present invention are polymeric compounds containing one or more amino groups which may be converted into cationic groups, for example by protonation or quaternization. According to the invention, such compounds as chitosan are particularly suitable in this regard.

Another suitable ingredient of an emulsion to be converted into droplets are low molecular weight compounds which adjust the viscosity or flow behavior of the emulsion. Glycerol is particularly suitable in this regard.

Another suitable constituent of an emulsion to be converted into droplets are pH-adjusting compounds. In the present case, the pH of the emulsion is in the range from pH 4 to 7 and preferably in the range from about pH 4.3 to 5. Dilute hydrochloric acid, acetic acid or glutaric acid, for example, may be used to adjust the pH.

In a preferred embodiment of the present invention, an emulsion to be converted into droplets has the following approximate composition for example:
about 50 to about 90% by weight and more particularly about 65 to about 75% by weight water
about 0.2 to about 4% by weight and more particularly about 0.5 to about 2.5% by weight of a structuring polymer, more particularly sodium alginate
about 10 to about 40% by weight and more particularly about 15 to about 40% by weight of an organic compound with a melting point of about 0 to about 50° C. or a mixture of two or more such compounds, the mixture having a melting point in the above range
about 0 to about 25% by weight and more particularly about 5 to about 15% by weight of a viscosity adjuster from the group of nonionic polymeric compounds, more particularly polyethylene glycol with a molecular weight of about 100 to about 500
about 0.1 to about 1.5% by weight and more particularly about 0.2 to about 0.8% by weight of an emulsifier
about 0.05 to about 0.7 and more particularly about 0.1 to about 0.4% by weight of a co-emulsifier,
0 to about 2% by weight of a cationic polymer, more particularly chitosan, and
0 to about 15% by weight glycerol.

The emulsions used in the process according to the invention are adjusted with the above-mentioned compounds to a viscosity of about 20 to about 500 mPas and more particularly to a viscosity of about 50 to about 150 mPas.

To produce regularly shaped droplets with a narrow size distribution, a frequency may additionally be applied to the stream of the organic/aqueous emulsion. The frequency may be applied by a vibrating membrane, a vibrating plate, a pulsating feed stream, an electrical field or a sonic field.

The droplets formed by the process described above are introduced into a precipitation bath to form the PCM sponges used in accordance with the invention. Suitable precipitation baths contain at least one divalent or polyvalent cation. Basically, any polyvalent cations which form an ionic bond with the structuring polymers present in the emulsion of sufficient strength to cross link the structuring polymer are suitable. Polyvalent metal ions, more especially the cations of metals of the 2nd and 3rd Main Group of the Periodic System of Elements, are particularly suitable. Magnesium ions, calcium ions or aluminium ions are preferably used.

When the emulsion to be converted into droplets is introduced into the precipitation bath, the structuring polymer obtained in the emulsion is crosslinked by the polyvalent cations present in the precipitation bath. Crosslinking is effected by the establishment of ionic bonds between the acid groups present in the structuring polymer, more particularly the carboxyl groups and the cations. The combination of acid groups in the structuring polymer and calcium or magnesium ions as cations in the precipitation bath is particularly suitable.

In a preferred embodiment of the present invention, a suitable precipitation bath contains about 0.1 to about 3% by weight of a salt of a polyvalent metal cation. The chlorides are particularly suitable. In a preferred embodiment of the present invention, a suitable precipitation bath contains about 0.7 to about 1.5% by weight of a corresponding salt, more particularly 0.7 to about 1.2% by weight calcium chloride. When the emulsion is added dropwise to the precipitation bath, a sponge-forming effect occurs under the effect of the osmotic gradient between the interior of the droplet and the precipitation bath surrounding the droplet. Water originally present inside the droplet diffuses therefrom into the surrounding precipitation bath, so that a sponge structure is formed. At the same time, however, the structuring polymer is crosslinked and hence the sponge structure strengthened by the admission of the polyvalent cations and in particular by the admission of calcium ions.

In a preferred embodiment of the present invention, a viscosity- increasing agent is added to the precipitation bath in order to improve the handling behavior of the precipitation bath and to facilitate removal of the PCM sponges therefrom. The viscosity-increasing agent is preferably a polyalkylene glycol, more particularly a water-soluble polyalkylene glycol, preferably polyethylene glycol. Suitable polyethylene glycols have a molecular weight of about 100 to about 1,000.

In order to obtain a uniform droplet form and to prevent droplets from coalescing with one another in the precipitation bath, rapid crosslinking of the droplet surface in the precipitation bath is desirable. Accordingly, to prevent individual droplets from being only partly immersed in the precipitation bath and hence to prevent part of the droplet surface from being crosslinked too slowly, it is of advantage to the process according to the invention for the precipitation bath to be in motion. Movement of the precipitation bath can be guaranteed by typical methods, for example simple agitation of the precipitation bath or pump-assisted circulation in a suitable vessel. In such a case, the process according to the invention may be carried out as a batch process.

However, it is equally possible, and preferred for the purposes of the invention, to carry out the process according to the invention continuously. To this end, the individual droplets are introduced into a stream of a precipitation bath solution which moves towards an element suitable for removing the PCM sponges. Corresponding streams of the precipitation bath solution can be created, for example, by the use of pumps and associated pump-assisted circulation of the precipitation bath solution.

In a preferred embodiment of the present invention, the residence time of the droplets in the precipitation bath is adjusted so that the total dwell time of the droplets in the continuous precipitation bath is about 0.5 to about 50 seconds and, more particularly, about 1 to about 10 seconds.

Basically, it is possible in the process according to the invention to select the dimensions of the above-described embodiment of the precipitation bath so that the PCM sponges formed can be removed from the precipitation bath stream by suitable methods, for example by filters or sieves or other solid/liquid separators.

However, sloping conveyor belts, for example, are particularly suitable for removing the PCM sponges. The PCM sponges can be freed from most of the adhering residues of the precipitation bath by a combined filtering, washing and drying process. To this end, the suspension of precipitation bath and PCM sponges is first freed from most of the precipitation bath in a first zone. The precipitation bath removed is collected and returned to the droplet forming zone.

The PCM sponges then pass through a second zone, a washing zone, on the filter belt where they are washed with water, for example with tap water or demineralized water.

In a final step, the filter belt passes, for example, through a drying zone where the PCM sponges are freed from residues of precipitation bath liquid, for example by the application of vacuum to the underneath of the filter belt.

However, it has also been found to be of advantage for the PCM sponges to be able to “rest” for a roughly defined period and continue crosslinking. To this end, the PCM sponges removed from the continuous precipitation bath are placed in a so-called “resting tank”. The PCM sponges continue crosslinking in the presence of calcium ions. At the same time, the water still present in the PCM sponges is removed from them by osmotic pressure. The mechanical stability of the PCM sponges increases in the resting tank. The residence time in the resting tank at this point is preferably 0.2 to 5 hours.

Basically, the PCM sponges produced in accordance with the invention, as part of the compositions according to the invention, are suitable for use in devices with which objects can be heated/cooled under control. Accordingly, the present invention also relates to the use of a particulate PCM sponge produced in accordance with the invention as a constituent of compositions for controlled heating/cooling by phase change (PCM).

In another embodiment of the present invention, a composition according to the invention is used as part of a device for the controlled heating/cooling of an object by phase change. Suitable devices comprise at least one container capable of holding a composition according to the invention.

Accordingly, the present invention also relates to a device for the controlled heating/cooling of an object by phase change at least comprising a container for holding a composition according to the invention.

Containers suitable for use in a device according to the invention may basically have any construction. The number of individual containers per device according to the invention is largely unlimited and may readily be adapted by the expert to suit the desired form of use of the device. However, in the interests of the flexible use of such a device for objects differing widely in their three-dimensional form, it has proved to be of advantage for the container to have a certain flexibility for adaptation to corresponding three-dimensional forms. In principle, the flexibility of a corresponding container may be substantially the same or only slightly different along each space axis of the container. According to the invention, however, a corresponding container may also differ in its flexibility along different space axes of the container.

According to the invention, a preferred device according to the invention is characterized in that the container has at least one of the following properties:
a) the container is flexible,
b) the container is closed on all sides,
c) the container has two or more compartments either separate from, or in liquid communication with, one another,
d) the container consists of an organic polymeric material,
e) the outer container material is formed by a film.

Basically, a device according to the invention may comprise a container which is open on one or more sides. In a preferred embodiment of the invention, however, the container is closed on all sides to prevent the composition according to the invention from escaping.

The three-dimensional form of a container which may be used in a device according to the invention is largely unlimited and, for example, may be adapted to a desired purpose in regard to the cooling of a specific object or a specific type of object. In a preferred embodiment, however, a corresponding container has a three-dimensional form basically extended in two spatial directions. This does not mean that such a container cannot be formed, for example, by joining the ends of such a flat container to make a cylinder, a cone or similar geometric shape. According to the invention, a device according to the invention may comprise a substantially flat container which may be made into various jacket forms and sleeves, for example via connecting points.

In addition, where a corresponding container is basically flat, it has proved to be of advantage to divide the container into several compartments which are optionally in liquid communication with one another. This division into different compartments is in itself sufficient to prevent the application of an external pressure to the container, as often occurs in practice, from displacing the entire composition according to the invention present inside the container at such a pressure point, so that the heating/cooling effect is partly eliminated.

An exemplary embodiment of a device according to the invention is described in the following with reference to the accompanying drawings, wherein:

FIG. 1 is a section through a flat, multi-compartment container. A wave-form cover film (2) is applied to an optionally heat-insulating basic film (1) and fixed in the wave troughs, for example by weld seams (3) or by bonding. The void (4) formed by the wave-like structure of the cover film is filled with a composition according to the invention.

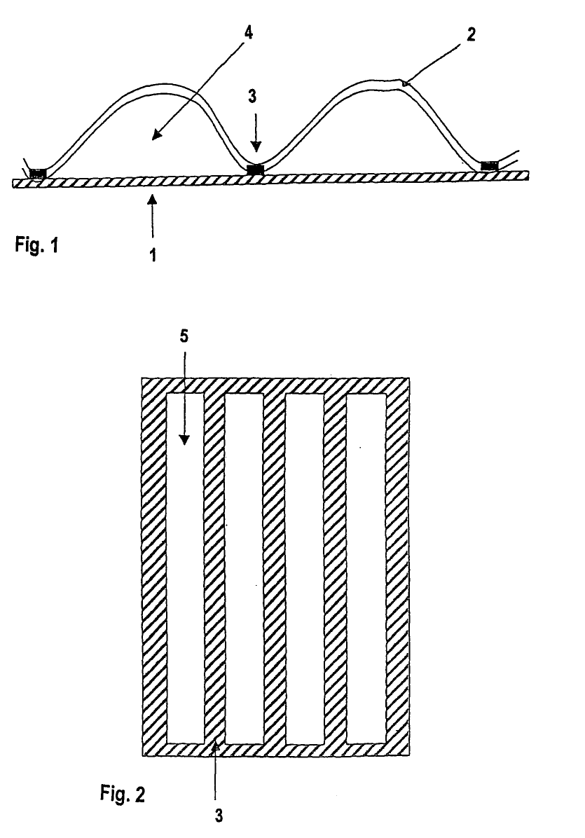

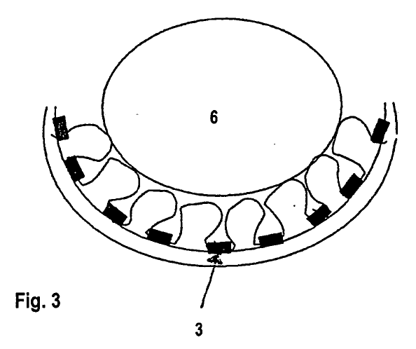

FIG. 2 is a plan view of a corresponding container. Tube-like voids (5) containing a composition according to the invention are alternately formed on the flat container by the weld seams (3).

FIG. 3 illustrates an application for such a container. By virtue of the increased flexibility along the weld seams (3), corresponding containers can be placed, for example, around such body parts as arms or legs (6) where they provide for a corresponding heating/cooling effect.

A film is preferably used as the tube for forming the container. The tube is filled with the composition of continuous and discontinuous phase and the edges are welded with a welding unit. Film bags differing widely in shape and length can be obtained in this way.

In another embodiment, the tube is repeatedly welded with a broad weld surface using a film welding unit. A structure comprising several interconnected film bags is formed in this way. In one particular embodiment, a perforation line is punched between the interconnected bags. This has the advantage that several bags can be combined to form a system. Depending on the particular application, interconnected bags can be separated off without effort and used in the form and number required for the particular system.

Polyethylene (PE), for example, may be used as the film material. An LDPE with an elongation of 400 to 600% is preferably used. It is inert to the composition and impervious. It can be welded at 105 to 115° C. Even after cooling to −20° C., PE is still elastic and does not turn brittle. In one particular embodiment, a double-layer film of polyethylene and polypropylene (PP or PET) is used. PE is the inner film which is in contact with the composition according to the invention. The PP or PET layer forms the elastic outer layer which is not welded during welding of the inner layer. This layer is impervious and resistant to chemicals. Adhesive labels can be applied to the outer layer of PP or PET.

The invention is illustrated by the following Examples.

### EXAMPLES

### Example 1

30% Fatty alcohol were dispersed at 50° C. in an aqueous solution containing 0.7% sodium alginate, 5% polyethylene glycol 200 and 0.25% cetyl stearyl alcohol +20 EO. 500 g of this solution were added dropwise to a precipitation bath containing 1% CaCl₂ and 5% polyethylene glycol 200. 250 g of PCM sponges with a diameter of 1-2 mm were formed. The PCM sponges were filtered off through a sieve. The PCM sponges could be exposed to even relatively high external pressures, for example between the fingers, without deliquescing or dispersing.

The PCM sponges were mixed with 10% by weight of a viscous gel based on water, glycerol and polyacrylate (Hispagel 200, a product of Cognis, D deutschland), introduced into a compartmented film bag and welded. A film-like container measuring 150 mm×250 mm was thus obtained. A commercially available bag of polyethylene for making ice cubes was used as the film bag. Through the combination of viscous gel and PCM sponges, the PCM sponges are able to move inside the compartments. Accordingly, only weak mechanical forces are generally transmitted to the PCM sponges. The film bag is not rigid, but is able to adapt flexibly to virtually any shape.

The PCM pad thus obtained was cooled overnight at 10° C. The heat transfer was tested on a glass condenser. Water with a temperature of 34 0C flowed through the glass condenser. The pad was placed around the condenser tube and the surface was isolated with a cloth. The temperature at the interface between the condenser tube and the pad rose in three hours from 14° C. to 31.5° C. On that side of the PCM pad remote from the condenser tube, the temperature initially remained constant at 17° C. for about 0.5 h (softening range of the gel). The temperature then rose to the melting temperature of the fatty alcohol (24° C.) and was kept there for about 1 hour until all the fatty alcohol had melted. Overall, a cooling effect was observed over a period of 3 hours.

### Example 2

18% C₁₂ fatty alcohol and 7% C₁₄ fatty alcohol were dispersed at 85° C. in an aqueous solution containing 1% sodium alginate and 0.6% oleyl cetyl alcohol +30 EO. 547 g/h of this solution were added dropwise to a precipitation bath containing 1% CaCl₂ kept at 15 0C. The PCM sponges were filtered off through a sieve. 565 g/h moist PCM sponges 2.5 to 3 mm in diameter were reweighed.

The PCM sponges were transferred to a resting tank containing 0.6% CaCl₂. After 3 days at 20° C., the PCM sponges had shrunk to 1.7-2 mm which corresponds to a reduction in volume by displacement of the water of 70%. No leakage of the fatty alcohol was observed during the shrinkage. Accordingly, the PCM sponge only contains organic phase change material and structuring polymer.

The PCM sponges could be exposed to even relatively high external pressures of 12 N/cm², for example between the fingers, without deliquescing or dispersing.

The melting behavior of the PCM sponges was studied by differential scanning calorimetry (DSC) with glycerol as the continuous phase. To this end, the PCM sponges were heated between −60° C. and 55° C. and cooled again a total of 4 times. The DSC measurement via the phase change temperature can be reproduced 4 times both during heating and during cooling. The sample shows a phase change temperature of 19 to 22° C. with a sharp melting peak of 34-35 kJ/kg.

The PCM sponges were mixed with 7% by weight of a viscous gel based on water, glycerol and polyacrylate (Hispagel 200, a product of Cognis, Deutschland), introduced into a film bag and welded. A container measuring 100 mm×100 mm was thus obtained. A commercially available film of the type marketed with household film welding units was used as the film bag. Even after cooling in a refrigerator or its freezer compartment, the film bag is not rigid, but can be flexibly adapted to virtually any shape both in the cold and in the hot state.

1-15. (canceled)

16. A heat or cold storage composition comprising at least one continuous phase and at least one discontinuous phase, wherein
(A) the continuous phase is liquid or at least plastic at a temperature of −10° C. to 50° C.; and
(B) the discontinuous phase
(1) is present in the continuous phase,
(2) is particulate,
(3) contains as phase change material at least 10% by weight of a mixture of two or more organic compounds with a melting point of 0° C. to 50° C., the mixture thereof having a melting point depression in relation to the individual components, and
(4) at least one structuring polymeric compound.

17. A heat or cold storage composition according to claim 16, wherein the continuous phase comprises an aqueous gel obtained by adding a substance to water which lowers its freezing point.

18. A heat or cold storage composition according to claim 17, wherein the substance added to water is selected from the group consisting of (a) ethylene glycol; (b) diethylene glycol; (c) propylene glycol; (d) glycerol; (e) diglycerol; (f) triglycerol; (g) monoesters of fatty acids having 2 to 8 carbon atoms with trimethylol propane, triethylol propane, pentaerythritol, sugar alcohols, or polyethylene glycols; (h) monoesters of oleic acid, linoleic acid or linolenic acid with trimethylol propane, triethylol propane, pentaerythritol, sugar alcohols, or polyethylene glycols with a molecular weight in the range from about 200 to about 600 kg/mol; (i) trimethylol propane; (j) triethylol propane; (k) pentaerythritol; (l) sugar alcohols; (m) polyethylene glycol; and (n) polyethylene glycols with a molecular weight in the range from about 200 to about 600 kg/mol.

19. A heat or cold storage composition according to claim 17, wherein the substance added to water comprises glycerol.

20. A heat or cold storage composition according to claim 16, wherein the continuous phase further comprises a thickener.

21. A heat or cold storage composition according to claim 20, wherein the thickener comprises a polyacrylic acid.

22. A heat or cold storage composition according to claim 16, wherein the two or more organic substances are obtained from natural renewable raw materials based on vegetable or animal fats and oils.

23. A heat or cold storage composition according to claim 16, wherein the organic substances are selected from the group consisting of aldehydes, alkanolamides, alkyl polyglycosides, fatty acid alkyl esters, fatty alcohols, ocenols, Guerbet alcohols, fatty acids, glycerols, ethoxylated glycerols, fatty acid mono-, di- and triglycerides, polyethylene glycols, alkyl sulfosuccinate salts, fatty alcohol sulfate salts, salts of fatty acids, ethoxylated triglycerides, and crystalline long-chain hydrocarbons having 10 to 18 carbon atoms.

24. A heat or cold storage composition according to claim 16, wherein the organic substances comprise a eutectic mixture when added to water.

25. A heat or cold storage composition according to claim 16, wherein the organic substances comprise a eutectic mixture of caproic acid and lauric acid or of a C₁₂ fatty alcohol and a C₁₄ fatty alcohol.

26. A heat or cold storage composition according to claim 16, wherein the structuring polymeric compound forms part of the discontinuous phase particle substantially throughout its cross-section.

27. A heat or cold storage composition according to claim 16, wherein the particle size of the discontinuous phase is between about 0.5 to about 4 mm.

28. A heat or cold storage composition according to claim 16, wherein the structuring polymeric compound comprises two or more anionic groups capable of entering into a stable crosslinking reaction with divalent or polyvalent cations.

29. A heat or cold storage composition according to claim 28, wherein the two or more anionic groups are carboxyl groups.

30. A heat or cold storage composition according to claim 16, wherein the structuring polymeric compound is selected from alginate or cellulose compounds.

31. A heat or cold storage composition according to claim 16, wherein the structuring polymeric compound is selected from a group consisting of sodium alginate, barium alginate, carboxymethylated chitin or chitosan, carboxymethyl starch, and carboxymethyl cellulose.

32. A heat or cold storage composition according to claim 16, wherein the particles of the discontinuous phase substantially retain their shape when the two or more organic compounds change back and forth between the liquid and solid phases.

33. A heat or cold storage composition according to claim 16, wherein the particles of the discontinuous phase, with the two or more organic compounds in the liquid phase, are capable of withstanding an external force of at least 5 N/cm².

34. A process for the production of a phase change material sponge particle, comprising
(a) combining water, at least one structuring polymeric compound having one or more acid groups, two or more water-insoluble organic compounds having a melting point of 0C to 50° C., and at least one emulsifier to form a droplet-forming aqueous emulsion; and
(b) adding the droplet-forming aqueous emulsion dropwise to a precipitation bath of an aqueous solution of a cation with a valency of at least two in relation to the acid groups of the structuring polymeric compound in such a way that droplets with an average droplet size of 0.5 to 4 mm are formed.

35. A process according to claim 34, wherein the structuring polymeric compound is selected from alginate and cellulose compounds.

36. A process according to claim 34, wherein the structuring polymeric compound is selected from a group consisting of sodium alginate, barium alginate, carboxymethylated chitin or chitosan, carboxymethyl starch, and carboxymethyl cellulose.

37. A process according to claim 34, wherein the organic compounds the organic substances are selected from the group consisting of aldehydes, alkanolamides, alkyl polyglycosides, fatty acid alkyl esters, fatty alcohols, ocenols, Guerbet alcohols, fatty acids, glycerols, ethoxylated glycerols, fatty acid mono-, di- and triglycerides, polyethylene glycols, alkyl sulfosuccinate salts, fatty alcohol sulfate salts, salts of fatty acids, ethoxylated triglycerides, and crystalline long-chain hydrocarbons having 10 to 18 carbon atoms.

38. A process according to claim 34, wherein the water-insoluble organic compounds comprise a eutectic mixture when added to water.

39. A process according to claim 34, wherein the emulsifier is selected from the group consisting of alkyl ethoxylates, monoglycerides, alkyl polyglycosides or soaps, more particularly fatty alcohol ethoxylates, fatty alcohol sulfates, secondary alkanesulfonates and linear alkylbenzene sulfonates.

40. A process according to claim 34, wherein the cation is selected from magnesium, calcium and aluminium cations.

41. A process according to claim 34, wherein the droplet-forming aqueous emulsion contains at least 10% by weight of the two or more water-insoluble organic compounds.

42. A process according to claim 34, wherein the a droplet-forming aqueous emulsion has a viscosity of about 20 mPas to about 500 mpas.

43. A process according to claim 34, wherein the aqueous solution of a cation with a valency of at least two in relation to the acid groups of the structuring polymeric compound is agitated during the dropwise addition.

44. A process according to claim 34, wherein the aqueous solution of a cation with a valency of at least two in relation to the acid groups of the structuring polymeric compound is agitated during the dropwise addition

45. A process according to claim 34, further comprising removing the droplets from the precipitation bath.

46. A process according to claim 45, wherein the droplets are removed from the precipitation bath after about 0.2 s to 2 mins.

47. A device for the controlled heating or cooling of an object by phase change comprising a container containing the composition of claim 1.

48. A device according to claim 47, further including a means to hold the container in contact with the object.

49. A phase change material particle comprising at least 10% by weight of a mixture of two or more organic compounds with a melting point of 0° C to 50° C., the mixture thereof having a melting point depression in relation to the individual components, and at least one structuring polymeric compound, which particle substantially retains its shape when the two or more organic compounds change back and forth between the liquid and sold phases and which is capable of withstanding an external force of at least 5 N/cm² before disintegrating.
